(19) United States
(12) Patent Application Publication
(10) Pub. No.: US 2010/0147604 A1
(43) Pub. Date: Jun. 17, 2010

(54) Plug-in electric automobile

(76) Inventor: Masami Sakita, San Francisco, CA (US)

Correspondence Address: MASAMI SAKITA, P.O. BOX 61089, PALO ALTO, CA, 94306-1089, US

(21) Appl. No.: 12/319,675

(22) Filed: Jan. 9, 2009

Related U.S. Application Data
(60) Provisional application No. 61/201,662, filed on Dec. 12, 2008.

(51) Int. Cl. B60K 1/04; B60R 16/04; G06F 19/00

(52) U.S. Cl. 180/65.1; 180/68.5; 701/22

(57) ABSTRACT

The preferred embodiment of the plug-in electric automobile includes a main body and an auxiliary battery system. The main body is equipped with an electric motor, a primary battery and hook up means to hook up the auxiliary battery system, a computer, and electric connecting means for the primary and auxiliary battery systems. The main body includes, at the rear section, a trunk room with a displaceable floor means. The trunk room without the displaceable floor means is at least partially an empty space to the rear and to the ground when the trunk door is in the opened state. The auxiliary battery mounted on a cart is hooked up to the main body in a non-articulated manner within the trunk room.

### DOMESTIC PRIORITY

This application is entitled to the benefit of Provisional Application No. 61/201,662 entitled “Plug-in Electric Automobile” filed on Dec. 12, 2008.

### FIELD OF THE INVENTION

This invention relates generally to plug-in electric automobiles, and more particularly to such automobiles that are equipped with an auxiliary battery system.

### BACKGROUND OF THE INVENTION

In recent years, much attention has been paid to the automobile that is energized by electric power. Under the currently available technologies, however, the automobile that uses electric power as the sole source of energy must carry a large, heavy and expensive battery for it to be able to reach a long distance without recharging or replacing the battery. Thus efforts are being maid by various parties to reduce the size of the battery carried by the electric automobile. One such method that does not involve improvements of the battery itself uses an auxiliary internal combustion (IC) engine to power the automobile after the battery runs out, and the other uses a smaller battery than a full-scale battery that is supported by a network of battery replacement and/or recharging facilities. The former has an advantage that it is able to travel a long distance without recharging or replacing the battery, but it has a drawback such that the automobile has to carry the extra weight of the IC power train, and the owner must pay for the power train. The latter has an advantage that its battery is not as heavy or costly as the full-scale battery, but it has a drawback such that the automobile still has to carry a relatively large and heavy battery, and must stop en route, albeit relatively infrequently, to recharge or replace the battery in long distance trips.

A battery that can be recharged in a matter of minutes is said to be under development. Though it is great news, the quickly rechargeable battery by itself will not fully solve the problem. This is because one of the main benefits of using the battery to power the automobile is that the battery can be charged at night using spare capacity of the power plant when the power charge rate is possibly less than that during the daytime.

The battery technology is advancing rapidly, and it is expected that the size, weight and cost will all decrease in the future. But, even with all possible advancements, the battery for the “true plug-in electric automobile” that is able to reach a long distance without recharging or replacing the battery probably will still remain very large, heavy and costly for the foreseeable future.

What is needed, the inventor of the present invention believes, is a plug-in electric automobile that is equipped with two batteries: one (the primary type) embedded in the main body of the automobile for every day use, and the other (the auxiliary type) that can be hooked up to the main body of the automobile as needed. The main body of the automobile and the auxiliary battery system may be sold in combination or separately. In either case, the automobile with the auxiliary battery must look stylish, and will have to be supported by a network of auxiliary battery system rental stations from which the owner of the automobile (with/without the auxiliary battery) will be able to rent the auxiliary battery system when he/she wants to drive a distance that cannot be reachable by either one or both batteries.

### OBJECTS OF THE INVENTION

An object of this invention is the provision of a plug-in electric automobile that is able to reach a “reasonably” long distance without recharging or replacing the battery, and that does not use an auxiliary internal combustion engine or require carrying of an excessively heavy battery all the time.

An object of this invention is the provision of a plug-in electric automobile in which changing of the battery does not require any special facility except for a simple tool.

An object of this invention is the provision of a plug-in electric automobile that satisfies the above conditions, and that looks stylish, and can be price-competitive and economical to operate.

### SUMMARY OF THE INVENTION

The plug-in electric automobile 10 of the preferred embodiment of the present invention includes an automobile's main body 20 and an auxiliary battery system 60. The main body 20 is equipped with an electric motor 22, a primary battery 24 and a couple of hook up means 26 to hook up the auxiliary battery system 60, a computer 28, and electric connecting means 30 and 32 to the power line for the primary battery 24 and the auxiliary battery 62 of the auxiliary battery system 60, respectively. The main body 20 includes, at the rear section, a trunk room 34 with a displaceable floor means 36. The trunk room 34 without the displaceable floor means 36 is an empty space to the ground enclosed by two concaved sidewalls 38, a front wall 40, and a trunk door 42 with a center part of the bumper 44 attached to it. The trunk room 34 is at least partially open to the rear and to the ground when the door 42 is in the opened state, and the trunk room 34 is accessible to the auxiliary battery system 60 from the rear. The lower part of the trunk room 34 is used to keep the auxiliary battery system 60 when it is hooked up to the main body 20. The upper part of the trunk room 34 is used as a smaller trunk room if possible.

The auxiliary battery system 60 includes the auxiliary battery 62 in a battery casing 63 mounted on a battery cart 64. The battery cart 64 has a platform with side members 66 with a hollow square cross section and supported by two wheels through springs 68 and shock absorbers 71. A ring-shaped coupling means 72 is affixed to the front end of the side member 66, and the battery cart 64 is hooked up to the main body 20 by joining the coupling means 72 of the auxiliary battery system 60 to the hook up means 26 of the main body 20. The use of two sets of hook-up means 26 and coupling means 72 guarantees non-articulate coupling of the auxiliary battery system to the main body.

The plug-in electric automobile 10 can be operated without the auxiliary battery system 60. The auxiliary battery system 60 is to be used when the owner of the automobile needs to drive the automobile more distance than that the primary battery 24 can manage to drive. If the primary battery 24 is designed to power the automobile for, for example, 60 miles without recharging it, most people would not need the auxiliary battery system under normal conditions. When the auxiliary battery system 60 is not hooked up to the main body 20 of the automobile the auxiliary battery system 60 may be used to power the home electricity needs during the daytime while both the primary and auxiliary batteries may be charged at night when the rate of electricity may be less expensive and the power plant will have enough spare capacity.

For a trip that exceeds the driving distance of the primary and the auxiliary batteries, the plug-in automobile 10 of the present invention may be powered by the auxiliary battery system 60 that may be rented out by an auxiliary battery system rental business. When the rental auxiliary battery system 60 is used, the auxiliary battery system 60 owned by the owner of the automobile will be kept at home.

The computer 28 is equipped with software that performs power management of the primary battery 24 and the auxiliary battery 62. When the automobile is operated while the auxiliary battery system 60 is hooked up to the main body 20, the computer 28 powers the motor of the automobile using the electricity stored in the auxiliary battery 62 before using the electricity stored in the primary battery 24.

### BRIEF DESCRIPTION OF THE DRAWINGS

The above description and other objects and advantages of this invention will become more clearly understood from the following description when considered with the accompanying drawings. It should be understood that the drawings are for purposes of illustration only and not by way of limitation of the invention. In the drawings, like reference characters refer to the same parts in the several views:

FIG. 1 is a schematic representation of a plug-in electric automobile of the preferred embodiment;

FIG. 2 is a vertical cross-sectional view of the trunk room;

FIG. 3 is a vertical cross-sectional view of the auxiliary battery system and the hook-up means;

FIG. 4 is a horizontal cross-sectional of the auxiliary battery system and the hook-up means;

FIG. 5 is a perspective view of the hook-up means of the main body and the coupling means of the auxiliary battery system;

FIG. 6 is a side view of the vertical movement stabilizer of the battery cart;

FIG. 7 is an auxiliary battery system loading/unloading device;

FIG. 8 is a view taken along B-B of FIG. 9 showing an alternative embodiment; and

FIG. 9 is a cross-sectional view of the alternative embodiment taken along A-A of FIG. 8.

### DETAILED DESCRIPTION OF THE INVENTION

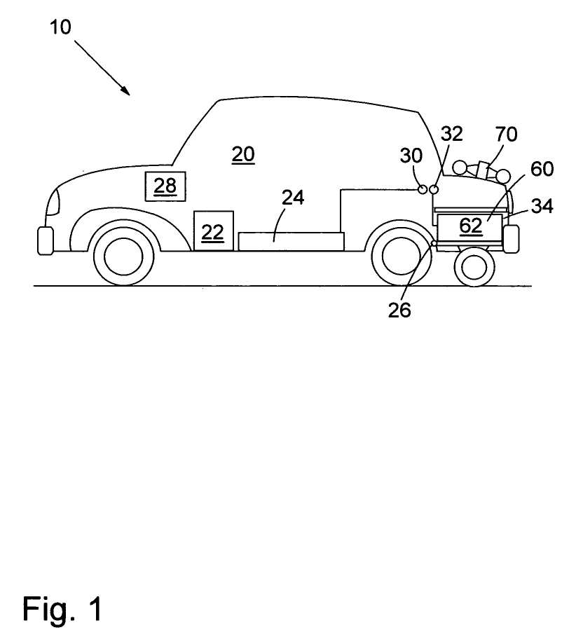

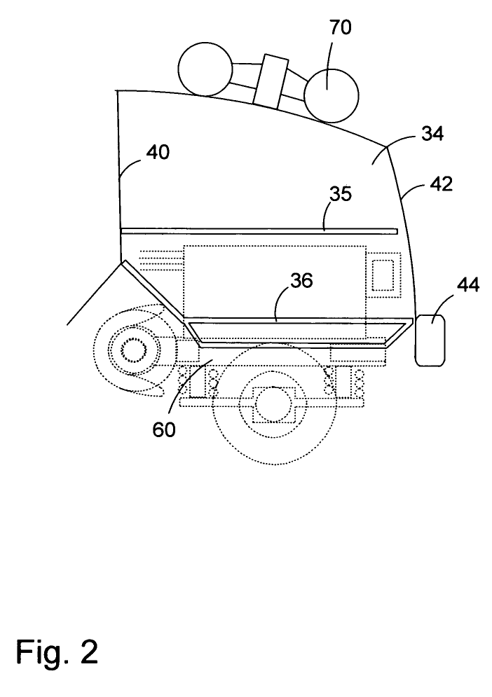

As shown in FIGS. 1 and 2, the plug-in electric automobile 10 of the preferred embodiment of the present invention includes an automobile's main body 20 and an auxiliary battery system 60. The main body 20 is equipped with an electric motor 22, a primary battery 24 and a couple of hook up means 26 to hook up the auxiliary battery system 60, a computer 28, and an electric connecting means 30 to the power line for the primary battery 24, and an electric connecting means 32 to the power line for the auxiliary battery 62 of the auxiliary battery system 60. The plug-in electric automobile 10 is operable using the primary battery 24 only without the auxiliary battery system 60. Here, the automobile is meant to include all land-use motorized vehicles.

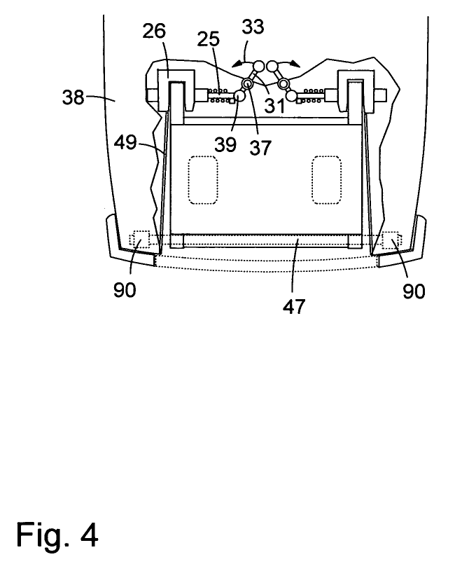

The main body 20 includes, at the rear section, a trunk room 34 with a displaceable floor means 36. The trunk room 34 without the displaceable floor means 36 is an empty space to the ground enclosed by two concave sidewalls 38, a front wall 40, and a trunk door 42 with a center part of the rear bumper 44 attached to the trunk door 42. The trunk room 34 is at least partially open to the rear and to the ground when the door 42 is in the opened state, and the trunk room 34 is accessible to the auxiliary battery system 60 from the rear. The hook-up means 26 is disposed in each side generally in front end of the trunk room 34. Because no gasoline is used in this plug-in electric automobile, there is no gas tank under the trunk room, and a spare tire 70 usually carried at the bottom in the ordinary sedan will have to be carried elsewhere, for example, on top of the trunk door 42 as shown in FIG. 1, or on the rear wall of the trunk room in an automobile of a non-sedan type. The lower part of the trunk room 34 is used to keep the auxiliary battery system 60 when it is hooked up to the main body 20. The upper part of the trunk room 34 is used as a smaller trunk room with another displaceable floor means 35 attached only when the auxiliary battery system 60 is hooked up to the main body 20. A metal rail 49 is disposed on each side edge of the hole of the trunk room floor (see FIG. 4). Each side edge of the displaceable floor means 36 is placed on top of the metal rail 49 when the auxiliary battery system 60 is not hooked up to the main body 20. The space at the rear of the main body 20 of the automobile may be solely used for keeping the auxiliary battery system 60, and not for carrying anything else. Even under such a case, this space is called a trunk room.

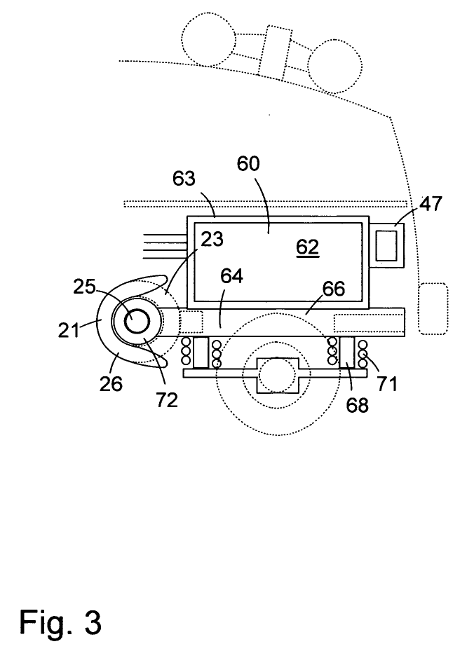

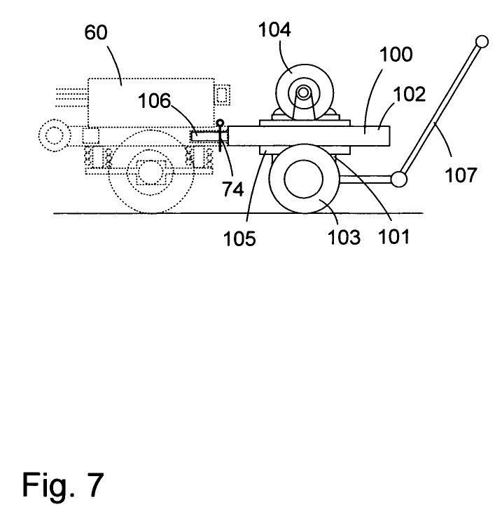

As shown in FIGS. 3 and 4, the auxiliary battery system 60 includes the auxiliary battery 62 in a battery casing 63 mounted on a battery cart 64. The battery cart 64 has a platform with side members 66 with a hollow square cross section and supported by two wheels through springs 68 and shock absorbers 71. A ring-shaped coupling means 72 is affixed to the front end of the side member 66, and the rear end of the side member 66 has a rectangular opening with one hole on the top wall and another hole on the bottom wall so that a connecting pin 74 (see FIG. 7) may be inserted vertically through these holes. The battery cart 64 is hooked up to the main body 20 by joining the coupling means 72 of the auxiliary battery system 60 to the hook up means 26 of the main body 20. The use of two sets of hook-up means 26 and coupling means 72 guarantees non-articulate coupling of the auxiliary battery system to the main body. A laterally extending telescopically extendable metal bar 47 with a rectangular cross section is affixed to the rear end of the battery cart 64 or the rear wall of the battery casing 63. The battery cart 64 may include a manually operable height adjustment system, which could be as simple as jack screw type supporting means of the wheel axles.

The auxiliary battery system 60 has a direct or indirect means to electrically connect to the electric motor 22 of the main body 20. In addition, the auxiliary battery system 60 has a means to connect to the electric connecting means 32 of the main body 20 so that the auxiliary battery 62 may be charged while it is being hooked up to the parked main body 20, and a means to connect to the house electric circuit or to the power line to directly charge the auxiliary battery from it and to discharge electricity to the house electric circuit as needed or to return the electricity to the power grid during the day while the auxiliary battery system 60 is parked by itself.

To load/unload the auxiliary battery system 60 into the main body 20, use a motorized battery cart loading/unloading device 100, and push/pull the battery cart 64 forward into the trunk room 34 of the main body (see FIGS. 4 and 7). In the loading process, the metal rails 49, which is also called a guide rail, disposed near two sides of the trunk room floor with the narrowing distance between them toward the front end guide the coupling means 72 of the side members 66 of the battery cart 64 toward the hook up means 26 of the main body as the metal rails 49 and the side members 66 are of about the same height.

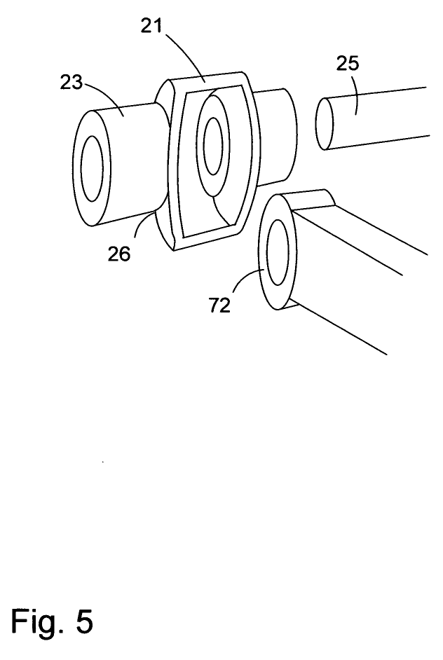

As shown in FIGS. 3, 4 and 5, the hook-up means 26 of the main body 20 includes a horizontally disposed center piece 21 with a V-shaped cross-section, two metal cylinders 23 with a coaxial hole affixed to each side of the center piece 21, and a slidable metal locking bar 25 that is slidably received by the coaxial holes of the metal cylinders 23. The lateral position of the slidable metal locking bar 25 may be controlled by a locking lever 31 that pivots around a fulcrum 37 and is connected to the locking bar 25 by a pin 39. The locking bar 25 is spring loaded so that it will stay in the locked position, which is the normal condition, under which the bar 25 penetrates through the coaxial holes of the metal cylinders 23. The operator of the locking lever 31 pulls the lever in the direction shown by an arrow 33 in FIG. 4 to set the locking bar 25 in the unlocked position prior to loading/unloading of the auxiliary battery system 60. In the loading process, after the ring-shaped coupling means 72 is inserted into the center piece 21, the locking bar 25 is returned to the locked position. Then the locking bar 25 penetrates not only through the coaxial holes of the two metal cylinders 23 but also through the ring-shaped coupling means 72.

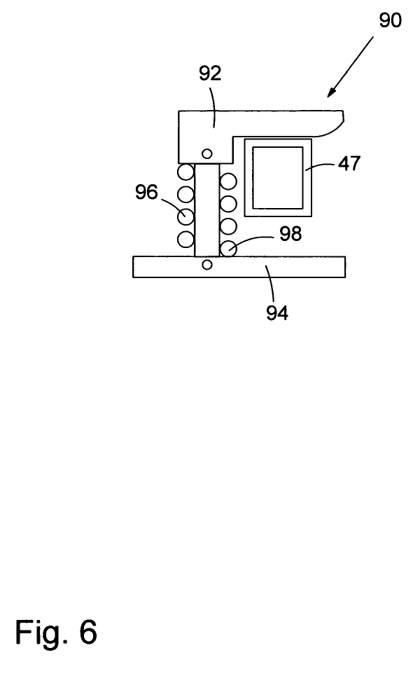

As shown in FIGS. 4 and 6, a base 94 of a vertical movement stabilizer 90 of the battery cart 64 is affixed to the main body 20 at each side of the trunk room floor of the main body 20. The vertical movement stabilizer 90 has a metal bar holder 92, which is upside down L shaped with an open rear end, and its vertical member is connected to the base 94 through a shock absorber 96, and a spring 98 slidably receives the metal bar 47 that is in the extended state.

As shown in FIG. 7, loading and unloading of the auxiliary battery system 60 into the main body 20 is done by using a manually operable motorized auxiliary battery system loading/unloading device 100. The loading/unloading device 100 has a bogie 101 to which two wheels 103, a motor 104 and a steering handle 107 are affixed, has a vertically cylindrical exterior side wall 105. The loading/unloading device 100 has a platform 102 with a cylindrical hole in the middle. The cylindrical hole of the platform receives the cylindrical exterior wall of the bogie 101 and the platform 102 is pivotally slidably mounted to the bogie 101. The platform 102 includes a side member on each side wherein which side member has a protruding rectangular metal member 106. The height of the rectangular member 106 relative to the surface of the ground is adjustable, and battery cart 64 and the loading/unloading device are coupled together by inserting the metal member 106 into the rear open end of the hollow rectangular metal member 66 of the battery cart 64. The rectangular metal member 106 has vertical hole through which and through the holes in the rectangular side member 66 of the battery cart 64, the pin 74 can be inserted.

The plug-in electric automobile 10 can be operated without the auxiliary battery system 60. When the auxiliary battery system 60 is not hooked up to the main body 20 of the automobile the auxiliary battery system 60 may be used to power the home electricity needs or return the electricity to the grid during the daytime while both primary and auxiliary batteries may be charged at night when the rate of electricity may be less expensive and the power plant has enough spare capacity.

For a trip that exceeds the driving distance of the primary and the auxiliary batteries, the plug-in automobile 10 may be powered by the auxiliary battery system 60 that may be rented out by an auxiliary battery system rental business. When the rental auxiliary battery system 60 is used, the auxiliary battery system 60 owned by the owner of the automobile will be kept at home.

The computer 28 is equipped with software that performs power management of the primary battery 24 and the auxiliary battery 62. When the automobile is operated while the auxiliary battery system 60 is hooked up to the main body 20, the computer 28 powers the motor of the automobile using the electricity stored in the auxiliary battery 62 before using the electricity stored in the primary battery 24. The computer is equipped with a man-machine interface system that shows the current status of power usage of the primary battery 24 and the auxiliary battery 62.

An alternative embodiment includes only one hook-up means of the main body and pairing coupling means of the auxiliary battery system. The hook-up means is disposed laterally in the middle and generally in front end of the trunk room. The hook-up means and the coupling means are both wider than those of the preferred embodiment, and they are coupled in a non-articulated manner as done in the preferred embodiment.

In another alternative embodiment, the center part of the rear bumper is affixed to a hinge that is affixed to the inner edge of one of the two side parts of the rear bumper. In another alternative embodiment, the main body has two side parts for the rear bumper, but does not have the center part of the rear bumper.

In another alternative embodiment, the trunk room comprises an upper part and the loser part, and the lower par of the trunk room has neither the center part of the rear bumper nor the rear door. In this case, the lower part of the trunk room is an open space to the rear and to the ground, and is used solely for keeping the auxiliary battery system. In such an automobile, the auxiliary battery, when it is hooked up to the main body, does not necessarily have to be contained within the boundary of the rear section of the automobile, and the auxiliary battery system may be equipped with a rear bumper of its own. In an automobile that has a relatively high floor, the auxiliary battery system of a relatively thin dimension may be hooked up to the main body under the automobile's floor in the rear section of the automobile. In these alternative embodiments that do not use the trunk room of the main body, the hook-up means and the guide rails that lead the coupling means of the auxiliary battery system toward the hook-up means are disposed under the floor in the rear section of the main body, and the locking mechanism of the hook-up means may be electro-mechanically operated.

In another alternative embodiment, the hook up means is disposed within the vicinity of the rear bumper, and the auxiliary battery system with the auxiliary battery mounted on a cart with a housing for the auxiliary battery is hooked up in a non-articulated manner to the main body. The battery cart may be equipped with its own rear bumper and rear and turn indicator lights.

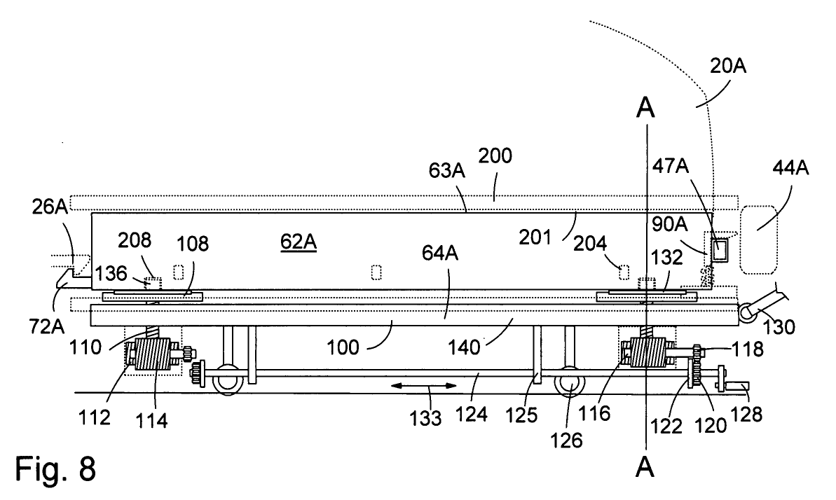

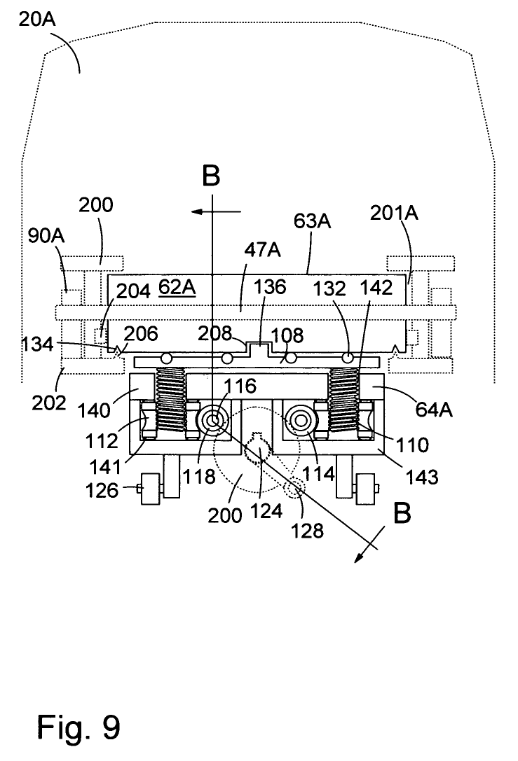

As shown in FIGS. 8 and 9, another alternative embodiment 10A uses a main body 20A that includes a chassis 200, and an auxiliary battery system 60A that includes an auxiliary battery 62A and a detachable battery cart 64A from the battery used for loading and unloading of the battery 62A to the main body 20A. The chassis includes two longitudinally disposed side members with a hollow space 201 between them. This space 201 created by the two side members keeps the auxiliary battery 62A. The rear end of the space 201 is open to the rear, and the bottom of the space 201 is mostly open to the ground. The bottom of the each side member of the chassis 200 has a flange 202, and two flanges 202 together hold the auxiliary battery 62A. The auxiliary battery 62A is inserted into the space 201 from the rear. The width and the height of the side members of the chassis 200 may vary as long as the width is wider and the height is higher toward the rear end, the distance between the two internal bottom edges of the flanges is the same in the length, and the upper surfaces of the two flanges are generally of the same height from the ground. The center part 44A of the rear bumper, which is in the extension of the rear end of the space 201, is affixed to a hinge that is affixed to the edge of a side part of the rear bumper, and can be opened when the auxiliary battery 62A is loaded into or out of the main body 20A.

The main body 20A includes a hook-up means 26A, and the auxiliary battery 62A includes a coupling means 72A. If the center part 44A of the rear bumper is able to hold the auxiliary battery 62A securely, the hook-up means and the coupling means may not be necessary, however. A groove 134 is cut along the length under the battery 62A in each side, wherein which groove slidably receives a rail 206, loosely during loading and unloading of the battery 62A, and tightly after loading the auxiliary battery 62A to the main body 20A. It must be apparent that the main body 20A can have an opening to the internal space not at the rear end but at the front end, and then the auxiliary battery 62A is loaded onto the main body 20A from the front end, and the front bumper instead of the rear bumper will have a center part pivotally connected to one of the side part of the front bumper. The auxiliary battery 62A is kept on the battery cart 64A while the battery 62A is not kept on the main body 20A. The battery cart 64A includes a main platform 140 that supports the auxiliary battery 62A indirectly, a plurality of wheels 126 preferably of a caster type, at least a pair of jackscrew assemblies 111, and a jackscrew driver means 121.

A pair of the jackscrew assemblies 111 is disposed side by side close to the front end and another close to the rear end of the battery cart 64A. The jackscrew assembly 111 includes a spindle 110 with a thread that meshes with the internal thread of a thimble 112 and has external worm gear teeth that mesh with the teeth of another worm gear 114 mounted on a driveshaft 116. The thimble 112 is mounted on needle bearings 141 that are supported by the main platform 140 and a jackscrew assembly casing 143 that is affixed to the bottom of the main platform 140. The spindles of the paired jackscrew assemblies have opposing threads: one has a right-hand thread and the other a left-hand thread. The worm gear 114 is mounted on the driveshaft 116. An adjustable platform 108 with a plurality of laterally rollable roller bearings 132 and a boss 136 is affixed to the top of the spindles 110 that protrude through holes 142 made in the main platform 140. As the driveshaft 116 turns, the worm gear 112 turns, and moves the adjustable platform 108 up or down.

The roller bearings 132 allow lateral movements of the battery 62A. The boss 136 that is received by a hole 208, with an ample space in each side of the boss 136 in the hole made on the bottom wall of the casing 63A of the battery 62A, prevents accidental fall of the battery 62A from the battery cart 64A, and enables pushing and pulling of the battery 62A by the battery cart 64A while loading/unloading of the battery 62A to the main body 20A. The internal wall of the side members of the chassis is equipped with a plurality of longitudinally rollable roller bearings 204 so that the battery 62A may be pushed forward or pulled backward without battery's sidewalls scraping the internal sidewalls of the side members of the automobile's chassis.

A gear 118 mounted on the driveshaft 116 in each of the jackscrew assembly pair meshes with a gear 120 that is mounted on the crankshaft 124. The crankshaft 124 is slidably received by a crankshaft holder 125, and the crankshaft 124 is slidable in the longitudinal directions as shown by an arrow 133. The distance between the two gears 120 is shorter than the distance between the two gears 118. A disc 122 is affixed to the inside surface of the gear 120, and thus as the crankshaft 124 is pushed toward the front, the disc 122 will slidably touch the internal surface of the gear 118, and thus the gear 120 near the front end will mesh with the gear 118 near the front end of the battery cart 64A, and as the crankshaft 124 is pushed toward the rear end, the gear 120 near the rear end will mesh with the gear 118 near the rear end of the battery cart 64A. By rotating the crankshaft 124, the height of the battery 62A relative to the flanges 202 of the chassis 200 at the front and the rear can be adjusted. The vertical stabilizer 90A attached to the side member of the chassis receives an extendable metal bar 47A that is affixed to the rear wall of the casing 63A of the battery 62A.

After loading the battery 62A onto the main body 20A, the battery cart 64A is removed from beneath the main body 20A. The battery cart 64A may have a handle 130 for pushing or pulling it manually. Or, the battery cart may be pulled/pushed by a motorized machine.

Another alternative embodiment uses the same main body 20 as in the preferred embodiment, and uses a detachable battery cart as in the embodiment 10A, and load the auxiliary battery, which has a ring-shaped coupling means that can be received by the main body's hook-up means, into the trunk room using a battery cart that is generally identical to the battery cart 64A of the alternative embodiment 10A. In this case, the battery is placed on top of the trunk room floor, and the battery cart may have only two wheels and a pair of jackscrews. This alternative design aims to take advantage of possible weight and size reduction of the auxiliary battery due to technological improvements in the future.

In all alternative embodiments, the electric connections between the main body and the auxiliary battery, and between the auxiliary battery and the power line are generally identical to those of the preferred embodiment.

The invention having been described in detail in accordance with the requirements of the U.S. Patent Statutes, various other changes and modifications will suggest themselves to those skilled in this art. In the preferred embodiment, the wheels and the coupling means may be directly affixed to the external walls of the casing of the auxiliary battery. In such a case, if the battery is taken out of the battery casing, what is left is nothing but a battery cart, and thus the battery can still be considered as mounted on a battery cart. Though it was not the original intent of this invention, the automobile that includes an internal combustion engine as in the plug-in hybrid automobile and the hybrid automobile is expected to is expected to be able to take advantage of this invention. In case of the hybrid automobile that does not have the plug-in capability by itself, if it is used as the base for the main body, together with the auxiliary battery system, the whole automobile will become a plug-in hybrid. Thus, the phrase “plug-in electric automobile” is intended to include the plug-in hybrid automobile, and the phrase “primary battery” is intended to include the non-pluggable battery mounted on the hybrid automobile. It is intended that above and other such changes and modifications shall fall within the spirit and scope of the invention defined in the appended claims.

I claim:

1. A main body of a plug-in electric automobile that includes a main body and an auxiliary battery system wherein
said main body includes an electric motor and a primary battery,
said electric motor drives said plug-in electric automobile at least part of the time,
said auxiliary battery system includes an auxiliary battery and a battery cart on which said auxiliary battery is mounted at least during loading and unloading of said auxiliary battery into and from said main body,
said battery cart includes a plurality of wheels,
said main body has an imaginary boundary,
said imaginary boundary encloses the space occupied by said main body and the empty space beneath said main body,
at least a part of said auxiliary battery system is able to enter into said imaginary boundary of said main body from longitudinally one end of said main body,
said plug-in automobile is operable without said auxiliary battery system, and
said primary battery powers said electric motor for at least part of the time while said plug-in electric automobile is operated without said auxiliary system.

2. A main body of a plug-in electric automobile as defined in claim 1 wherein
said auxiliary battery is kept on said battery cart during operation of said plug-in electric automobile,
said main body includes at least one hook-up means,
said auxiliary battery system includes at least one coupling means, and
said coupling means of said auxiliary battery system is coupled with said hook up means of said main body in a non-articulated manner.

3. A main body of a plug-in electric automobile as defined in claim 2 wherein
said hook-up means of said main body includes a horizontally disposed center piece with a V-shaped cross-section, two metal cylinders with a coaxial hole affixed to each side of said center piece,
said coupling means is ring-shaped,
said coupling means of said auxiliary battery system received by said center piece of said hook-up means, and
a slidable metal locking bar that is slidably received by said coaxial holes of said metal cylinders and said coupling means.

4. A main body of a plug-in electric automobile as defined in claim 1 wherein
said battery cart is removed from said main body during operation of said plug-in electric automobile.

5. A main body of a plug-in electric automobile as defined in claim 1 wherein
said main body includes a vertical movement stabilizer of said auxiliary battery system.

6. A main body of a plug-in electric automobile as defined in claim 1 wherein
said main body is equipped with a computer,
said computer includes computer software that performs power management of said primary battery and said auxiliary battery, and
said computer software powers said electric motor using electricity stored in said auxiliary battery before using electricity stored in said primary battery.

7. A main body of a plug-in electric automobile as defined in claim 1 wherein
said main body includes a chassis,
said chassis has two side members,
said side member includes a bottom flange, and
said auxiliary battery is at least partially supported by said flanges.

8. An auxiliary battery system of a plug-in electric automobile that includes a main body and an auxiliary battery system wherein
said main body includes an electric motor and a primary battery,
said electric motor drives said plug-in electric automobile at least part of the time,
said auxiliary battery system includes an auxiliary battery and a battery cart on which said auxiliary battery is mounted at least during loading and unloading of said auxiliary battery into and from said main body,
said battery cart includes a plurality of wheels,
said main body has an imaginary boundary,
said imaginary boundary encloses the space occupied by said main body and the empty space beneath said main body,
at least a part of said auxiliary battery system is able to enter into said imaginary boundary of said main body from longitudinally one end of said main body,
said plug-in automobile is operable without said auxiliary battery system, and
said primary battery powers said electric motor for at least part of the time while said plug-in electric automobile is operated without said auxiliary system.

9. An auxiliary battery system of a plug-in electric automobile as defined in claim 8 wherein
said auxiliary battery is kept on said battery cart during operation of said plug-in electric automobile,
said main body includes at least one hook-up means,
said auxiliary battery system includes at least one coupling means, and
said coupling means of said auxiliary battery system is coupled with said hook up means of said main body in a non-articulated manner.

10. An auxiliary battery system of a plug-in electric automobile as defined in claim 9 wherein
said auxiliary battery is contained in a battery casing, and
said battery casing is an integral part of said battery cart.

11. An auxiliary battery system of a plug-in electric automobile as defined in claim 9 wherein
said hook-up means of said main body includes a horizontally disposed center piece with a V-shaped cross-section, two metal cylinders with a coaxial hole affixed to each side of said center piece,
said coupling means is ring-shaped,
said coupling means of said auxiliary battery system received by said center piece of said hook-up means, and
a slidable metal locking bar that is slidably received by said coaxial holes of said metal cylinders and said coupling means.

12. An auxiliary battery system of a plug-in electric automobile as defined in claim 8 wherein
said battery cart is removed from said main body during operation of said plug-in electric automobile.

13. An auxiliary battery system of a plug-in electric automobile as defined in claim 8 wherein
said auxiliary battery system includes a means to electrically connect to said main body, and a means to connect to power line to directly charge said auxiliary battery and to discharge electricity from said auxiliary battery as needed while said auxiliary battery system is parked by itself.

14. An auxiliary battery system of a plug-in electric automobile as defined in claim 8 wherein
said battery cart includes at least one adjustable platform on which said auxiliary battery is mounted, and a mechanism that adjusts height of said adjustable platform.

15. A battery cart used during loading and unloading of a battery into a plug-in electric automobile wherein
said plug-in automobile is accessible to said battery cart from longitudinally one end of said main body,
said battery cart includes at least one adjustable platform and a plurality of wheels,
said battery to be loaded into said plug-in electric automobile is mounted on said adjustable platform, and
said battery cart includes a mechanism that adjusts height of said adjustable platform.

16. A battery cart as defined in claim 15 wherein
said mechanism that adjusts height of said adjustable platform includes at least one pair of jackscrew assemblies wherein
said jackscrew assembly includes a jackscrew and a means to drive said jackscrew.

17. A battery cart as defined in claim 16 wherein
said mechanism that adjusts height of said adjustable platform includes two pairs of jackscrew assemblies wherein
each pair of said jackscrew assemblies is able to adjust height of said adjustable platform independently of each other.

18. A battery cart as defined in claim 15 wherein
said battery cart includes a plurality of roller bearings on upper surface of said adjustable platform.

20. A battery cart as defined in claim 15 wherein said wheels are casters.
